(19) United States
(12) Patent Application Publication
(10) Pub. No.: US 2021/0297837 A1
(43) Pub. Date: Sep. 23, 2021

(54) RELIEF SYSTEM USING PORTABLE ENERGY STORAGE SYSTEM AND WIRELESS COMMUNICATION

(71) Applicant: ENERCAMP CO., LTD., Daegu (KR)

(72) Inventor: Jungsub CHOI, Daegu (KR)

(21) Appl. No.: 16/340,349

(22) PCT Filed: Nov. 21, 2018
(86) PCT No.: PCT/KR2018/014345

§ 371 Date: Apr. 8, 2019

(30) Foreign Application Priority Data
Oct. 16, 2018 (KR) 10-2018-0122996

(51) Int. Cl. H04W 4/90; H04W 4/029

(52) U.S. Cl. CPC H04W 4/90; H04W 88/08; H04W 4/029

(57) ABSTRACT

According to a proposed relief system using a portable energy storage system and wireless communication, a wireless communication module that forms a local wireless network is mounted in a portable energy storage system to provide wireless communication between terminals within the local wireless network formed by the wireless communication module to allow the terminals within the local wireless network to communicate with each other to inquire safety or identify their locations in areas or situations in which communication is impossible.

### TECHNICAL FIELD

The present disclosure relates to a relief system, and more particularly, to a relief system using a portable energy storage system and wireless communication.

### BACKGROUND

Every year, massive human and economic losses are incurred by accidents or natural disasters. Recently, areas affected by extreme weather, earthquakes and tidal waves has increased all over the world, and large-scale blackouts and cessation of communication occur. Therefore, there is a need to make plans to prepare for accidents or disasters and minimize damage, as well as developing the technology to prepare for situations in which it is impossible to send a request for help or make a call due to communication network destruction.

Additionally, with the increasing leisure time, growth of the leisure industry and increasing interest in camping, the population participating in camping continues to grow. Consequently, there is an increased likelihood that accidents may occur during a variety of leisure activities such as camping. However, if accidents occur during camping, fishing, or climbing in secluded areas with poor communication network, it may be difficult to send a request for help, and responses to accidents may be delayed, causing additional damage.

Moreover, communication is often disconnected, for example, in large national parks in foreign countries, and there is no systematic communication network in mountains, so it may be difficult to send a request for help in emergency situations. Therefore, there is a need for a technology to prepare for emergency situations.

As related art, Korean Patent Publication No. 10-2003-0075938 (Title: Emergency relief system and method using mobile communication network, published Sep. 26, 2003), Korean Patent Publication No. 10-2013-0143264 (Title: System and method for real-time emergency services, and storage medium recording program for implementing method thereof, published Dec. 31, 2013), and Korean Patent Publication No. 10-2016-0033377 (Title: Apparatus and method for receiving relief signal and society safety network system using moveable relief signal receiver, published Mar. 28, 2016) are disclosed.

However, most of relief systems uses a mobile communication network, and such relief systems cannot be applied in areas in which communication is impossible due to the destroyed communication networks or lack of facilities. Accordingly, there is an urgent need to develop technologies to send a request for help in situations when communication is impossible, for example, in accident/disaster affected areas or camping zones.

### SUMMARY

The present disclosure is proposed to solve the above-described problems of earlier proposed methods, and therefore, the present disclosure is directed to providing a relief system using a portable energy storage system and wireless communication in which a wireless communication module that forms a local wireless network is mounted in a portable energy storage system to provide wireless communication between terminals within the local wireless network formed by the wireless communication module to allow the terminals within the local wireless network to communicate with each other to inquire after safety or identify their locations in areas or situations in which communication is impossible.

The present disclosure is further directed to providing a relief system using a portable energy storage system and wireless communication further including a portable terminal on which an applied program for monitoring the portable energy storage system and the wireless communication module is installed to remotely control the portable energy storage system using the applied program installed in the portable terminal and transmit a danger signal related to accident or disaster situations to terminals within the local wireless network to share information about imminent dangers with the terminals and prepare for emergency situations.

To achieve the above-described objects, a relief system using a portable energy storage system and wireless communication according to the feature of the present disclosure is a relief system including a portable energy storage system (P-ESS), and a wireless communication module mounted in the portable energy storage system to form a local wireless network, wherein wireless communication is provided between terminals within the local wireless network formed by the wireless communication module.

Preferably, at least one selected from the group consisting of call, message transmission/reception, location information transmission/reception and danger information transmission/reception may be provided using the wireless communication between terminals within the local wireless network formed by the wireless communication module.

Preferably, the wireless communication module may form the local wireless network when a preset condition is satisfied.

More preferably, the preset condition may be limited network availability or accident situation.

Preferably, the local wireless network may include at least one selected from the group consisting of WiFi, Bluetooth, Long-Term Evolution (LTE) and Global Positioning System (GPS).

Preferably, the relief system may further include a portable terminal on which an applied program for monitoring the portable energy storage system and the wireless communication module is installed.

More preferably, the portable terminal may connect to an Internet of Things (IoT) sensor through the local wireless network to collect and analyze data collected from the IoT sensor.

More preferably, the portable terminal may transmit a danger signal to a terminal within the local wireless network according to a result of the analysis.

According to the proposed relief system using a portable energy storage system and wireless communication, a wireless communication module that forms a local wireless network is mounted in a portable energy storage system to provide wireless communication between terminals within the local wireless network formed by the wireless communication module to allow the terminals within the local wireless network to communicate with each other to inquire after safety or identify their locations in areas or situations in which communication is impossible.

In addition, according to the proposed relief system using a portable energy storage system and wireless communication, the relief system further includes a portable terminal on which an applied program for monitoring the portable energy storage system and the wireless communication module is installed to remotely control the portable energy storage system using the applied program installed in the portable terminal and transmit a danger signal related to accident or disaster situations to terminals within the local wireless network to share information about imminent dangers with the terminals and prepare for emergency situations.

### BRIEF DESCRIPTION OF THE DRAWINGS

FIG. 1 is a diagram showing the configuration of a relief system using a portable energy storage system and wireless communication according to an embodiment of the present disclosure.

FIG. 2 is a diagram showing an example of a portable energy storage system of a relief system using the portable energy storage system and wireless communication according to an embodiment of the present disclosure.

FIG. 3 is a diagram showing an example of the display of a terminal within a local wireless network, in a relief system using a portable energy storage system and wireless communication according to an embodiment of the present disclosure.

FIG. 4 is a diagram showing an example of wireless communication provided between terminals within a local wireless network, in a relief system using a portable energy storage system and wireless communication according to an embodiment of the present disclosure.

FIG. 5 is a diagram showing an example of a portable terminal, in a relief system using a portable energy storage system and wireless communication according to an embodiment of the present disclosure.

### DETAILED DESCRIPTION OF MAIN ELEMENTS

100: Portable energy storage system according to an embodiment of the present disclosure
110: Wireless communication module
200: Portable terminal
210: Applied program

### DETAILED DESCRIPTION OF EMBODIMENTS

Hereinafter, preferred embodiments will be described in sufficient detail to enable those skilled in the art to easily practice the present disclosure with reference to the accompanying drawings. However, in describing the preferred embodiments of the present disclosure, when it is deemed that a detailed description of relevant known functions or elements renders the key subject matter of the present disclosure unnecessarily ambiguous, the detailed description is omitted herein. Additionally, identical reference signs are used for elements with similar functions and operations throughout the drawings.

In addition, throughout the specification, it will be understood that when an element is referred to as being ‘connected to’ another element, it can be directly connected to the other element or intervening elements may be present. Unless the context clearly indicates otherwise, it will be further understood that the term ‘comprises’ or ‘includes’ when used in this specification, specifies the presence of stated elements, but does not preclude the presence or addition of one or more other elements.

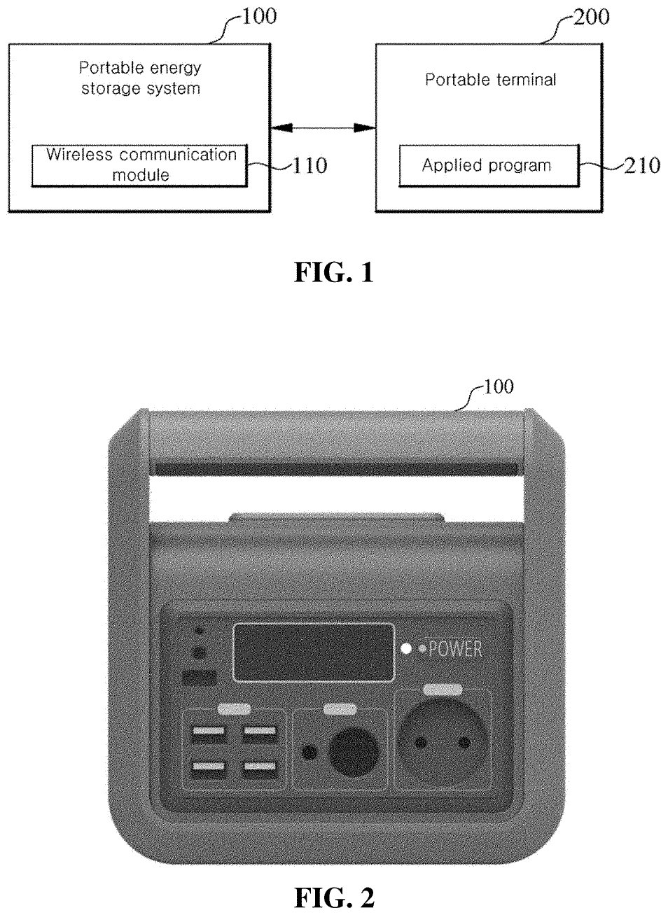

FIG. 1 is a diagram showing the configuration of a relief system using a Portable Energy Storage System (P-ESS) 100 and wireless communication according to an embodiment of the present disclosure. As shown in FIG. 1, the relief system using a portable energy storage system 100 and wireless communication according to an embodiment of the present disclosure may include a portable energy storage system (P-ESS) 100, and a wireless communication module 110 is mounted in the portable energy storage system 100, and may further include a portable terminal 200 on which an applied program 210 for monitoring the portable energy storage system 100 and the wireless communication module 110 is installed.

Hereinafter, each component of the relief system using the portable energy storage system 100 and wireless communication according to an embodiment of the present disclosure will be described in detail.

The portable energy storage system 100 is a small-sized system of an energy storage system (ESS) that stores and manages energy for efficient use of energy. The portable energy storage system 100 stores power, and in situations in which power is needed, it efficiently supplies power and is small, lightweight, and portable. The portable energy storage system 100 may stably supply power in environments in which accidents or disasters occurred, or it is difficult to use power, for example, during camping. Especially, due to the size and weight reduction, it is possible to easily use at homes, and it is possible to use when power is in need outdoors when it is provided vehicles. Recently, it may be used as an emergency product to prepare for various accidents/disasters through the dustproof and waterproof design for the purpose of use in emergency situations.

FIG. 2 is a diagram showing an example of the portable energy storage system 100 of the relief system using the portable energy storage system 100 and wireless communication according to the embodiment of the present disclosure. As shown in FIG. 2, the portable energy storage system 100 of the relief system using the portable energy storage system 100 and wireless communication according to the embodiment of the present disclosure may have a handle to make it easy to carry, and may be lightweight enough for a person to carry alone. Additionally, the portable energy storage system 100 may have many types of outlets to supply power to various devices using the portable energy storage system 100, and may include a display device to see the condition of the portable energy storage system 100.

The wireless communication module 110 may be mounted in the portable energy storage system 100 to form a local wireless network. That is, the wireless communication module 110 may be mounted inside the portable energy storage system 100 as shown in FIG. 2, so that a local wireless network may be formed by the wireless communication module 110. The wireless communication module 110 may be implemented in the form of a board that can be inserted into the portable energy storage system 100, and the portable energy storage system 100 may apply power to the wireless communication module 110 to operate the wireless communication module 110. The relief system using the portable energy storage system 100 and wireless communication according to an embodiment of the present disclosure may provide wireless communication between terminals within the local wireless network formed by the wireless communication module 110.

Here, the wireless communication module 110 may form the local wireless network when a preset condition is satisfied, and the preset condition may be limited network availability or accident situations. For example, the wireless communication module 110 may form the local wireless network in situations in which network availability is limited in areas outside of the coverage of wireless Internet or mobile communication network commonly used and when network availability is limited by destruction of a base station or a communication network due to accidents/disasters. To determine whether the preset condition is satisfied, the wireless communication module 110 may receive a signal from the portable terminal 200 to be described in detail later.

In this instance, the local wireless network may include at least one of the following: WiFi, Bluetooth, Long-Term Evolution (LTE) and Global Positioning System (GPS). That is, the wireless communication module 110 acts as a sort of communication hub to allow different types of terminals located within the local wireless network to exchange a signal and data with each other.

In more detail, the relief system using the portable energy storage system 100 and wireless communication according to the embodiment of the present disclosure may provide at least one of the following: message transmission/reception, location information transmission/reception and danger information transmission/reception using wireless communication between terminals within the local wireless network formed by the wireless communication module 110 in situations in which the preset condition is satisfied, such as environments in which a telephone call, transmission/reception of a message such as SMS or MMS, location information transmission/reception and Internet availability are limited.

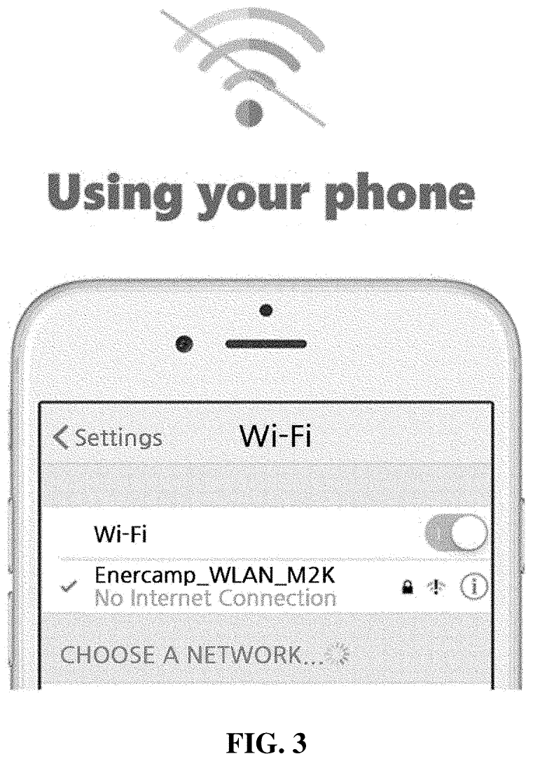

FIG. 3 is a diagram showing an example of the display of a terminal within the local wireless network, in the relief system using the portable energy storage system 100 and wireless communication according to the embodiment of the present disclosure. As shown in FIG. 3, in limited network availability or accident situations, when the wireless communication module 110 forms a local wireless network, a terminal located within the formed local wireless network may exchange information with other terminals only by selecting the corresponding network. According to the embodiments, the local wireless network may be automatically selected without a separate network selection process.

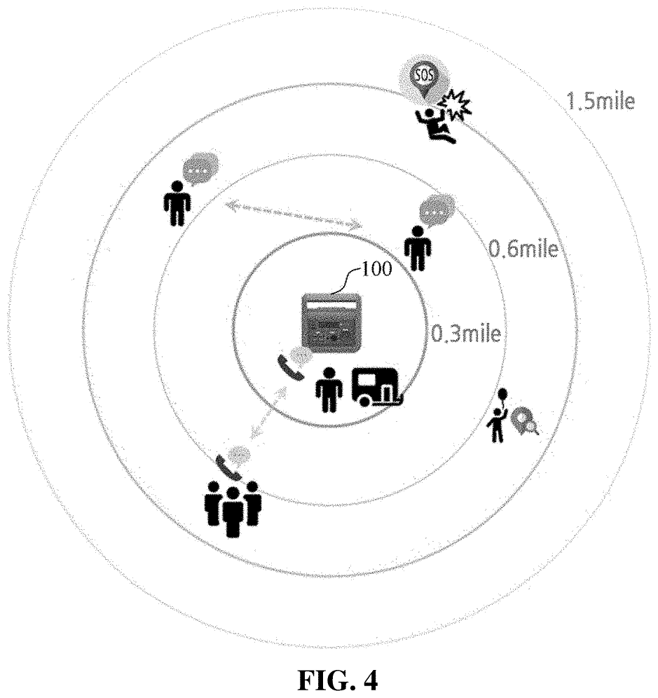

FIG. 4 is a diagram showing an example of wireless communication provided between terminals within the local wireless network, in the relief system using the portable energy storage system 100 and wireless communication according to the embodiment of the present disclosure. As shown in FIG. 4, the wireless communication module 110 of the relief system using the portable energy storage system 100 and wireless communication according to the embodiment of the present disclosure may form a local wireless network within a predetermined distance, and for example, may form a local wireless network that serves a 1.5 mile radius from the portable energy storage system 100 having the wireless communication module 110 mounted therein.

Users within the local wireless network may access the local wireless network formed by the wireless communication module 110 using terminals as shown in FIG. 3, and may make a call and transmit and receive a message, location information and danger information such as SOS request as shown in FIG. 4. For example, the terminal may transmit location information to a terminal of a firefighter who entered the corresponding local wireless network area, to allow the firefighter to perform a fast rescue. Additionally, in accident or disaster situations, terminals in the corresponding area may inquire safety or share necessary information using telephone calls or messages.

The portable terminal 200 may have the applied program 210 installed therein to monitor the portable energy storage system 100 and the wireless communication module 110. Here, the applied program 210 may be an application that can monitor the condition of the portable energy storage system 100 and enable remote control.

Additionally, the portable terminal 200 includes various types of mobile smart devices that are possible to carry with and can install the applied program 210, for example, Smart phone, Tablet PC, Smart Watch and Wearable device. However, the portable terminal 200 of the present disclosure is not limited to the types of terminals listed above, and any type of terminal that is possible to carry with and can install the applied program 210 may act as the portable terminal 200 of the present disclosure regardless of the shape.

Meanwhile, the portable terminal 200 may connect to an IoT sensor through the local wireless network to collect and analyze data collected from the IoT sensor. That is, the portable terminal 200 may access an IoT sensor located within the local wireless network to collect sensing data. Additionally, the portable terminal 200 may transmit a danger signal to a terminal within the local wireless network according to a result of the analysis.

For example, the portable terminal 200 may collect real-time temperature data from a temperature sensor, and analyze a temperature variation. When the collected temperature data increases above a preset maximum temperature threshold or reduces below a minimum temperature threshold, it is a situation in which heatstroke or hypothermia may occur, and thus the portable terminal 200 may transmit a related danger signal to a terminal within the local wireless network. Additionally, when the temperature variation is above a preset threshold, it is a situation in which a rapid temperature change may threaten health, and thus the portable terminal 200 may transmit a danger signal.

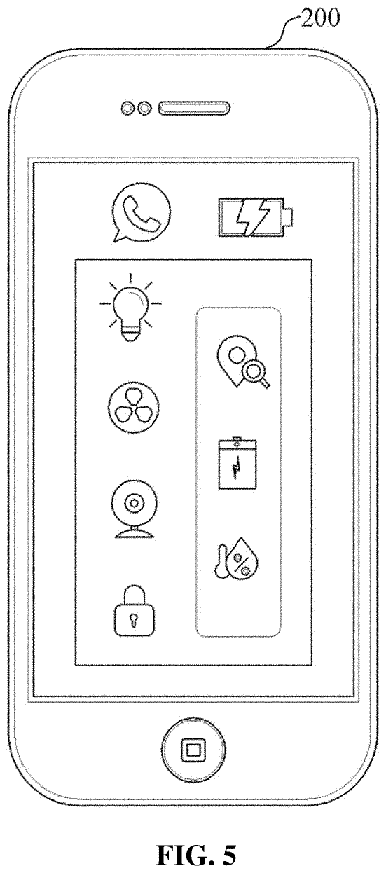

FIG. 5 is a diagram showing an example of the portable terminal 200, in the relief system using the portable energy storage system 100 and wireless communication according to the embodiment of the present disclosure. As shown in FIG. 5, the relief system using the portable energy storage system 100 and wireless communication according to the embodiment of the present disclosure may run the applied application installed in the portable terminal 200 and transmit a remote control signal to the portable energy storage system 100 to enable remote control, and input a local wireless network activation signal from the wireless communication module 110. Additionally, it is possible to monitor a state of charge, the remaining power amount, the amount of power used for each category, and the condition of the local wireless network formed by the wireless communication module 110. The user may see detailed information by selecting an icon as shown in FIG. 5. Additionally, the user may make a telephone call or transmit/receive a message with other terminal within the local wireless network using a telephone icon, and control the connection with the IoT sensor using a thermometer and water drop icon and see sensing data collected from the connected IoT sensor. As described above, according to the proposed relief system using the portable energy storage system 100 and wireless communication, the wireless communication module 110 that forms a local wireless network is mounted in the portable energy storage system 100 to provide wireless communication between terminals within the local wireless network formed by the wireless communication module 110 to allow the terminals within the local wireless network to communicate with each other to inquire safety or identify their locations in areas or situations in which communication is impossible.

Additionally, according to the present disclosure, the relief system may further include the portable terminal 200 on which the applied program 210 for monitoring the portable energy storage system 100 and the wireless communication module 110 is installed, to remotely control the portable energy storage system 100 by using the applied program 210 installed in the portable terminal 200 and transmit a danger signal related to accident or disaster situations to terminals within the local wireless network to share information about imminent dangers with the terminals and prepare for emergency situations.

While the present disclosure has been hereinabove described, various modifications or variations may be made thereto by those skilled in the art, and the technical spirit and scope of the present disclosure should be defined by the appended claims.

1-8. (canceled)

9. A relief system using a portable energy storage system and wireless communication, comprising:
the portable energy storage system (P-ESS); and
a wireless communication processor mounted in the portable energy storage configured to provide a local wireless network,
wherein the wireless communication is provided between a plurality of terminals within the local wireless network provided by the wireless communication processor.

10. The relief system according to claim 9, wherein at least one communication service selected from the group consisting of call, message transmission/reception, location information transmission/reception and danger information transmission/reception is provided using the wireless communication between the plurality of terminals within the local wireless network provided by the wireless communication processor.

11. The relief system according to claim 9, wherein the wireless communication processor provides the local wireless network when a preset condition is satisfied.

12. The relief system according to claim 11, wherein the preset condition is limited network availability or an accident situation.

13. The relief system according to claim 9, wherein the local wireless network includes at least one selected from the group consisting of WiFi, Bluetooth, Long-Term Evolution (LTE) and Global Positioning System (GPS).

14. The relief system according to claim 9, further comprising:
a portable terminal having installed therein an application program for monitoring the portable energy storage and the wireless communication processor.

15. The relief system according to claim 14, wherein the portable terminal connects to an Internet of Things (IoT) sensor through the local wireless network to collect and analyze data collected from the IoT sensor.

16. The relief system according to claim 15, wherein the portable terminal transmits a danger signal to at least one of the plurality of terminals within the local wireless network according to a result of the analysis of the data collected from the IoT sensor.
